(19) United States
(12) Patent Application Publication
(10) Pub. No.: US 2026/0067935 A1
(43) Pub. Date: Mar. 5, 2026

(54) SELECTION AND RESELECTION OF RANDOM ACCESS CHANNEL OCCASIONS UNDER PHYSICAL RANDOM ACCESS CHANNEL ADAPTATION

(71) Applicant: QUALCOMM Incorporated, San Diego, CA (US)

(72) Inventors: Ahmed Attia ABOTABL, San Diego, CA (US); Navid ABEDINI, Basking Ridge, NJ (US)

(21) Appl. No.: 18/817,554

(22) Filed: Aug. 28, 2024

(51) Int. Cl. H04W 74/0833; H04B 17/10

(52) U.S. Cl. CPC H04W 74/0833; H04B 17/101

(57) ABSTRACT

Certain aspects of the present disclosure provide techniques for selection and reselection of random access channel (RACH) occasions (ROs) under physical RACH (PRACH) adaptation. An example method, performed at a user equipment (UE), generally includes receiving signaling indicating adaptation of a first set of one or more random access channel (RACH) occasions (ROs), wherein the adaptation results in a second set of one or more ROs, selecting an RO of the second set that was added via the adaptation, based on one or more rules, and transmitting a RACH preamble in the selected RO.

### FIELD OF THE DISCLOSURE

Aspects of the present disclosure relate to wireless communications, and more particularly, to techniques for selection and reselection of random access channel (RACH) occasions (ROs) under physical RACH (PRACH) adaptation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving signaling indicating adaptation of a first set of one or more random access channel (RACH) occasions (ROs), wherein the adaptation results in a second set of one or more ROs; selecting an RO of the second set that was added via the adaptation, based on one or more rules; and transmitting a RACH preamble in the selected RO.

Another aspect provides a method for wireless communication at a network entity. The method includes transmitting signaling indicating adaptation of a first set of one or more random access channel (RACH) occasions (ROs), wherein the adaptation results in a second set of one or more ROs; selecting an RO of the second set that was added via the adaptation, based on one or more rules; and monitoring for a RACH preamble transmission in the selected RO.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow diagram illustrating an example four-step random access channel (RACH) procedure, in accordance with certain aspects of the present disclosure.

FIG. 6 depicts an example association of SSBs to RACH occasions (ROs).

FIG. 7A depicts a diagram illustrating example PRACH adaptation involving adding ROs.

FIG. 7B depicts a diagram illustrating example PRACH adaptation involving muting ROs.

FIG. 8 depicts a call flow diagram illustrating association period based PRACH adaptation and activation, in accordance with aspects of the present disclosure.

FIG. 9 depicts a diagram illustrating PRACH adaptation adding RO(s) and a rule indicating to use an added RO for at least a minimum number of PRACH preamble (re)transmissions, in accordance with aspects of the present disclosure.

FIG. 10 depicts a diagram illustrating PRACH adaptation adding RO(s) and a rule indicating to use an added RO for up to a maximum number of PRACH preamble (re)transmissions, in accordance with aspects of the present disclosure.

FIG. 11 depicts a diagram illustrating an indication that one or more ROs may be implicitly muted without additional indication, in accordance with aspects of the present disclosure.

FIG. 12 depicts a method for wireless communications.

FIG. 13 depicts a method for wireless communications.

FIG. 14 depicts aspects of an example communications device.

### DETAILED DESCRIPTION

Aspects of the present disclosure relate to wireless communications, and more particularly, to techniques for supporting random access channel (RACH) adaptation.

A Physical Random Access Channel (PRACH) generally refers to a channel used by user equipment (UE) to initiate communication with a base station (e.g., a gNB) in a cellular network. For example, as part of a random access (RA) channel procedure, the UE may send a preamble on the PRACH, after detecting a synchronization signal block (SSB) transmitted by the gNB. After successfully decoding a PRACH preamble, the gNB may respond with a Random Access Response (RAR) containing a Temporary Cell Identifier (TCI) and a timing advance (TA) value. The UE uses the TCI and TA to synchronize with the gNB and to access the network.

A random access channel (RACH) occasion (RO) generally refers to a specific time and frequency resource that maps to an SSB. The UE transmits a preamble sequence on the time and frequency resources of an RO mapped to an SSB detected by the UE, to initiate a Random Access (RA) procedure. The gNB uses the timing and frequency information associated with the RO to detect and decode the preamble and responds with the RAR.

As energy cost and environmental impact become an increasing concern, various network energy savings (NES) techniques have been considered to reduce power consumption. Some such NES techniques involve adaptation of transmissions and/or receptions in time, frequency, spatial, or power domains. For example, the number or periodicity of SSB transmissions, as well as ROs for corresponding PRACH transmissions, could be adapted in the time domain in an effort to save power.

In some cases, PRACH adaptation in the time domain may occur in two steps. A first step may involve radio resource control (RRC) configuration of extra ROs (e.g., through a separate PRACH configuration index or a different PRACH periodicity). A second step may involve activation of the configured extra ROs.

In typical scenarios, a UE selects an RO that corresponds (maps) to a strongest SSB beam (measurement) during initial access. If multiple ROs correspond to the same SSB, it may be left up to the UE implementation to select which of the multiple ROs to use. For example, a UE could select from the ROs at random, in an effort to reduce the collision probability (e.g., where another UE transmits PRACH on the same RO). This approach may be based on an assumption that there is no difference between the ROs, as may be the case when ROs are all configured through system information or RRC configuration for connected UEs.

This approach may be less than ideal, however, in PRACH adaptation scenarios where additional ROs are dynamically activated. In such cases, a UE that supports PRACH adaptation may have a baseline RO configuration which is also used by UEs that do not support PRACH adaptation (so called legacy UEs), as well as additional ROs (activated either dynamically or semi-statically) that are only used by UEs that support PRACH adaptation.

Potential issues may arise if a UE selects one of the extra ROs (activated via PRACH adaptation) for a first PRACH transmission or for a PRACH retransmission. For example, if the UE selects one of the extra ROs and the network transmits a deactivation indication that the UE fails to detect, the UE may keep transmitting PRACH preambles on the same RO without receiving a network response (as the network will stop monitoring this RO after the deactivation).

Aspects of the present disclosure provide mechanisms that may help regulate selection and/or re-selection of ROs added via PRACH adaptation. The mechanisms may effectively allow the network to encourage (or discourage) a UE from selecting certain ROs. For example, the network may signal one or more thresholds for the UE to apply before using extra ROs (e.g., based on reference signal received power-RSRP of corresponding SSBs). The threshold may help the network encourage only UEs located at a cell center to use added/extra ROs, because they have a higher reliability in receiving an adaptation indication (e.g., deactivating extra ROs).

The mechanisms proposed herein may, thus, help avoid the potential issue described above where a UE transmits on an RO that has been deactivated. As a result, the mechanisms proposed herein may lead to improved resource utilization, reduced UE power consumption, and better performance (as a PRACH may only be transmitted in active ROs).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

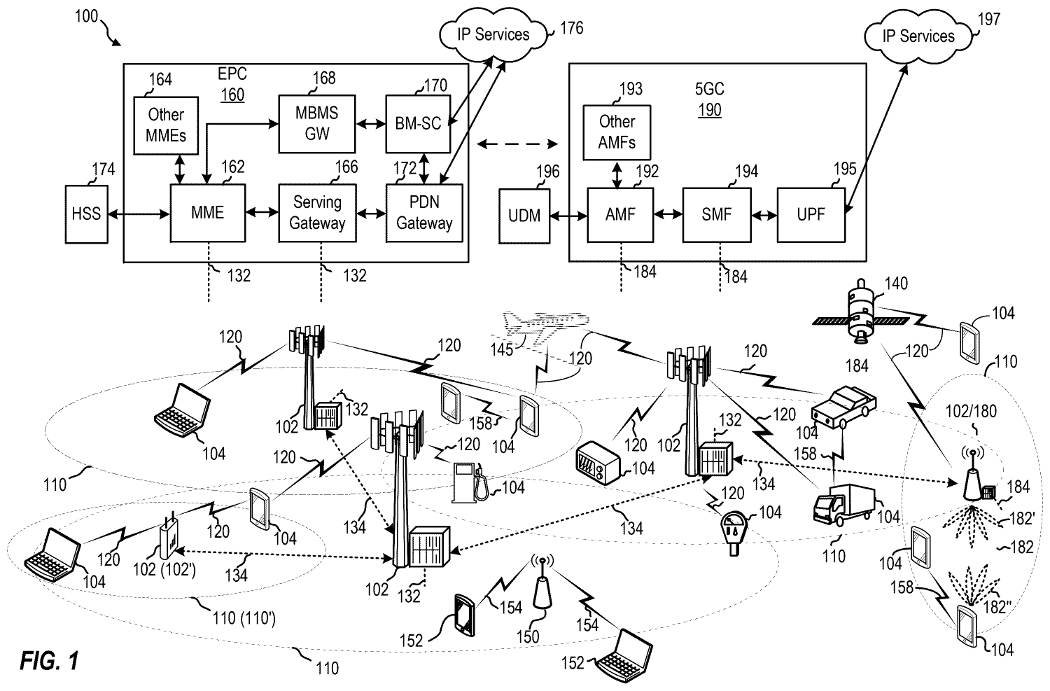

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

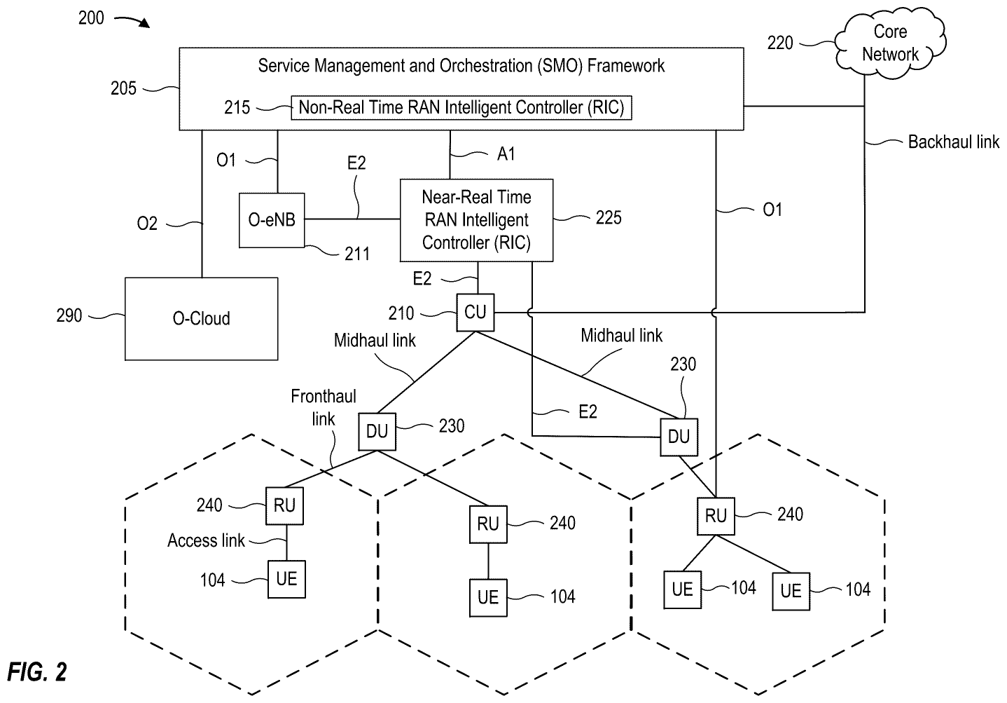

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

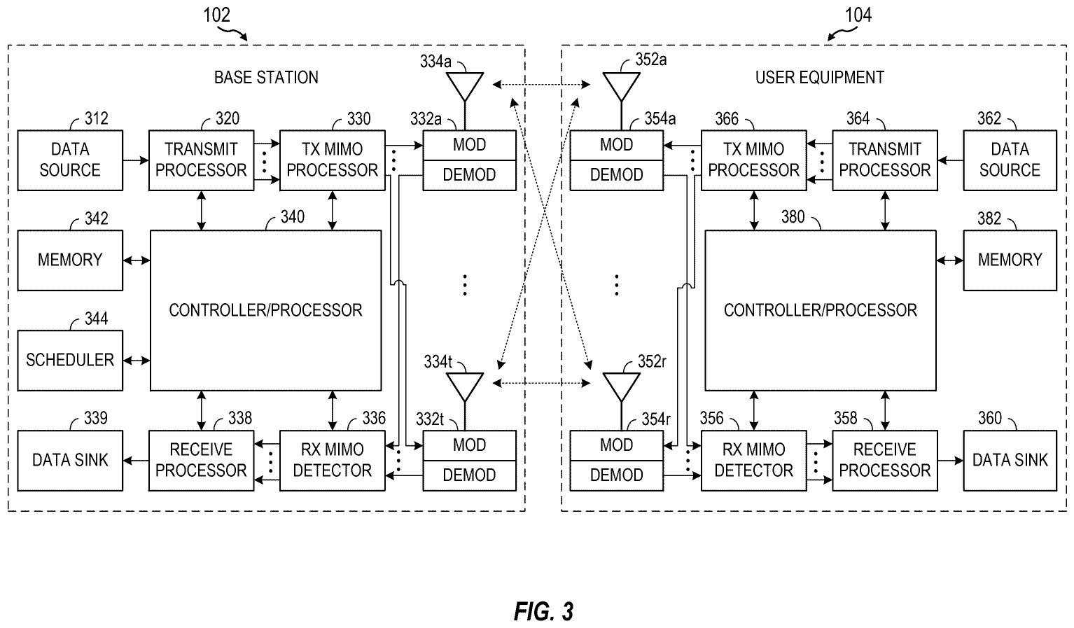

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

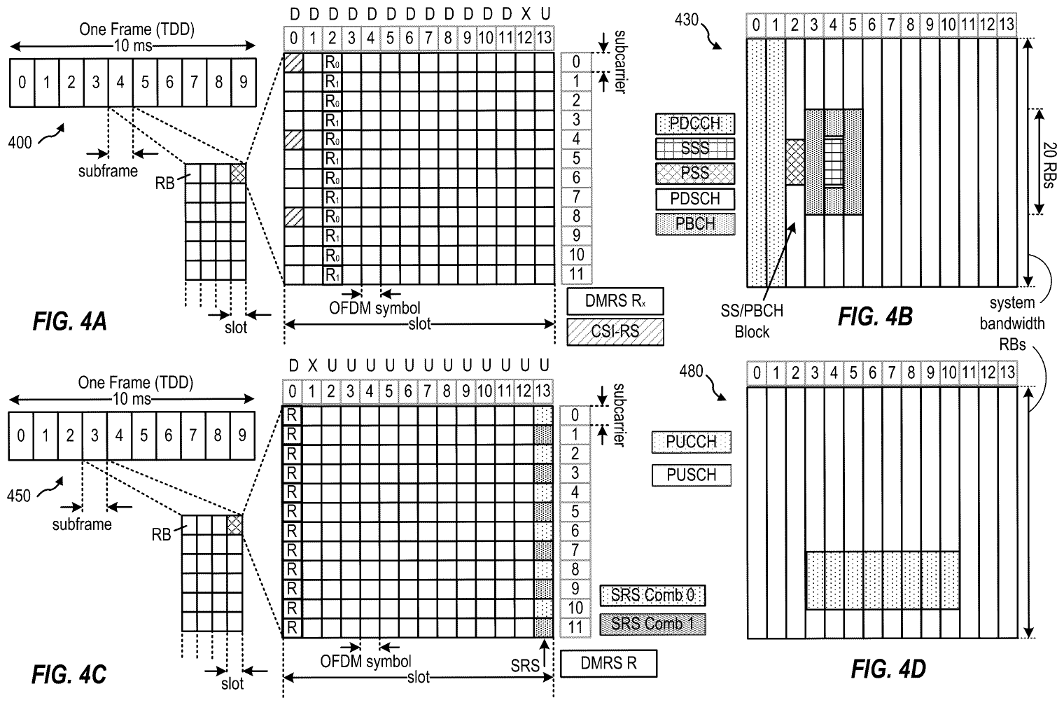

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Random Access Channel (RACH) Occasions (ROs)

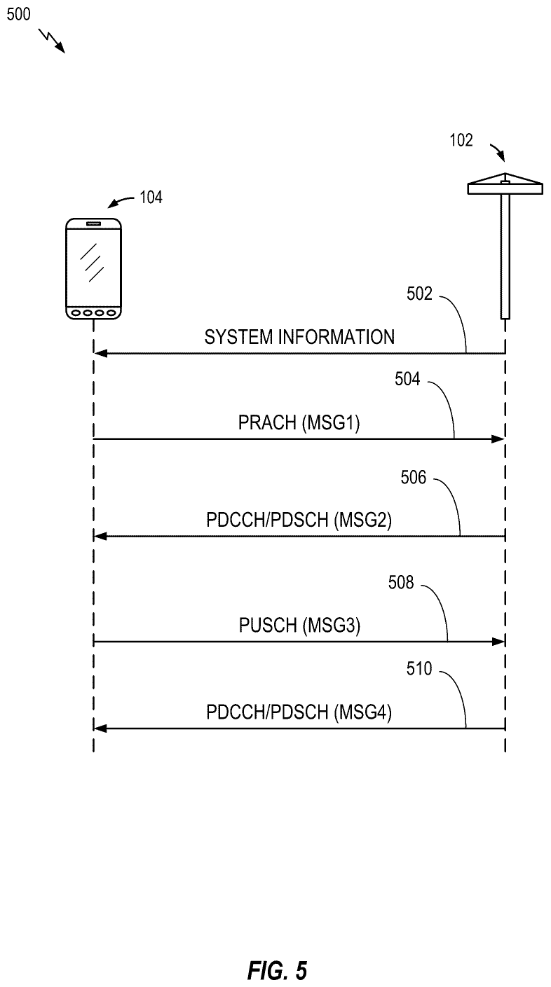

FIG. 5 is a call-flow diagram 500 illustrating an example four-step RACH procedure, in accordance with certain aspects of the present disclosure. A first message (MSG1) may be sent from the UE 104 to BS 102 on the physical random access channel (PRACH). In this case, MSG1 may only include a RACH preamble 504. BS 102 may respond with a random access response (RAR) message 506 (MSG2) which may include the identifier (ID) of the RACH preamble, a timing advance (TA), an uplink grant, cell radio network temporary identifier (C-RNTI), and a back off indicator (BI). MSG2 may include a PDCCH communication including control information for (e.g., scheduling a reception of) a following communication on the PDSCH, as illustrated. In response to MSG2, MSG3 is transmitted from the UE 104 to BS 102 on the PUSCH 508. MSG3 may include one or more of an RRC connection request, a tracking area update request, a system information request, a positioning fix or positioning signal request, or a scheduling request. The BS 102 then responds with MSG4 which may include a contention resolution message 510. In some cases, the UE 104 may also receive system information 502 (e.g., also referred to herein as a system information message) indicating various communication parameters that may be used by the UE 104 for communicating with the BS 102.

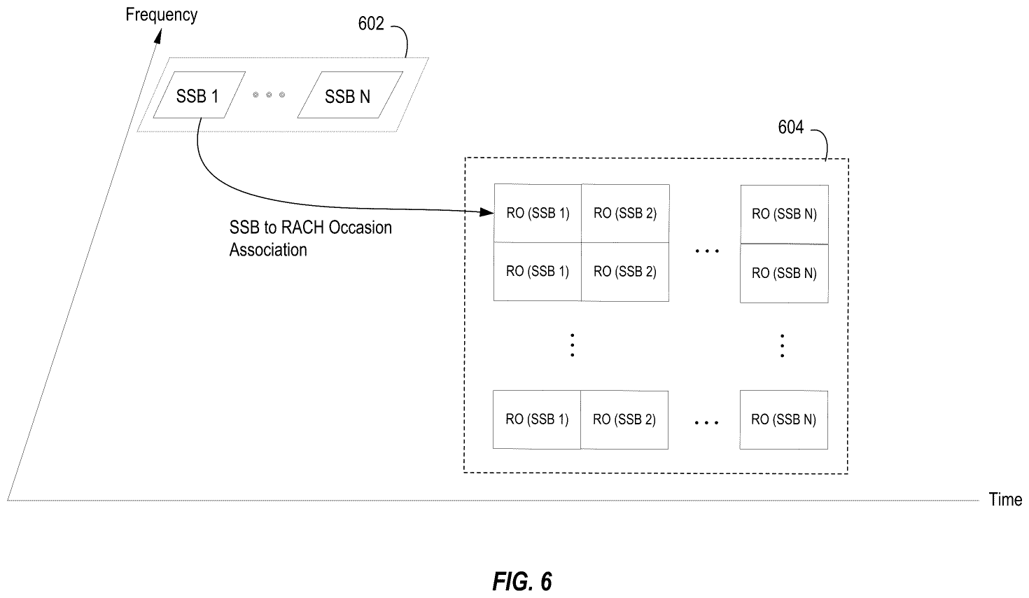

FIG. 6 depicts an example association (e.g., mapping) of SSBs 602 to RACH occasions (ROs) 604. This SSB to RO association is used for the gNB to know what beam the UE has acquired/is using (generally referred to as beam establishment). One SSB may be associated with one or more ROs or more than one SSB may be associated with one RO. Association is typically performed in the frequency domain first, then in the time domain within a RACH slot, then in the time domain across RACH slots (e.g., beginning with lower SSB indexes). An association period is typically defined as a minimum number of RACH configuration periods, such that all (configured) SSB beams are mapped into ROs.

In some cases, SSBs/beams detected in one BWP may be mapped to ROs in another BWP. In such cases, aspects of the present disclosure may adjust PRACH related timing to account for BWP switching (e.g., extending a timeline in which the UE is expected to transmit a PRACH to account for additional BWP switching delay).

### Overview of Prach Triggering and Cell Mobility

PRACH triggering from a network entity may be based on higher layer signaling (e.g., RRC) or, in some cases, lower layer signaling such as a physical downlink control channel (PDCCH). In some cases, PRACH transmissions for uplink (UL) timing in a candidate cell may be triggered via a downlink control information (DCI) from a serving cell.

Triggering PRACH transmissions may be beneficial in certain scenarios, for example, where a UE may move between a preconfigured set of candidate cells. In the illustrated example, the UE moves from a first cell (e.g., an old serving/primary cell) to a new serving candidate cell. In this case, the UE may not receive data or control information in the candidate cell, but may transmit a PRACH in order to facilitate timing adjustment for the new candidate cell before a cell change.

In some cases, a RACH may be triggered via a cell switch command MAC-CE. For example, a cell switch command MAC-CE may be sent by a source/serving cell in order to trigger a RACH transmission in a candidate/target cell.

### Overview of Dynamic Signaling-Based Mobility

As noted above, dynamic mobility signaling (e.g., L1 and/or L2-centric mobility or LTM) may lead to more efficient intra-cell and inter-cell mobility with reduced latency.

In some cases, the network may configure (e.g., via RRC signaling), a set of cells for L1/L2 mobility (referred to herein as an L1/L2 Mobility Configured cell set). At any given time, the network may also configure (via L1/L2 signaling) an L1/L2 Mobility Activated cell set, which refers to a group of cells in the configured set that are activated and can be readily used for data and control transfer. The network may also configure (signal) an L1/L2 Mobility Deactivated cell set, which refers to a group of cells in the configured set that are deactivated and can be readily activated by L1/L2 signaling.

L1/L2 signaling may be used for mobility management of the activated set. For example, L1/L2 signaling may be used to activate/deactivate cells in the set, select beams within the activated cells, and update/switch a primary cell (PCell). This dynamic signaling may help provide seamless mobility within the activated cells in the set. In other words, as the UE moves, the cells from the set are deactivated and activated by L1/L2 signaling. The cells to activate and deactivate may be based on various factors, such as signal quality (measurements) and loading.

In some cases, all cells in the L1/L2 Mobility Configured cell set may belong to a same DU of a CU. This may be similar to carrier aggregation (CA), but cells may be on the same carrier frequencies. The size of the cell set configured for L1/L2 mobility signaling may vary. In general, the cell set size may be selected to be large enough to cover a meaningful mobility area.

In some cases, the UE may be provided with a subset of deactivated cells, as a candidate cell set, from which the UE could autonomously choose to add to the activated cell set. The decision of whether to add a cell from the candidate cell set to the activated cell set may be a based various factors, such as measured channel quality and loading information. In some cases, the ability for the UE to autonomously choose to add to the activated cell set may be similar to a UE decision when configured for Conditional Handover (CHO) for fast and efficient addition of the prepared cells.

In some cases, each cell may be served by an RU, and each of the RUs may have multi-carrier (N CCs) support. In such cases, each CC may be a cell (e.g., Cell 2 and Cell 2′ may be different CCs of the same RU). In such cases, activation/deactivation can be done in groups of carriers (cells).

For PCell management, L1/L2 signaling may be used to set (select) the PCell out of the preconfigured options within the activated cell set. In some cases, L3 mobility may be used for PCell change (L3 handover) when a new PCell is not from the activated cell set for L1/L2 mobility. In such cases, RRC signaling may update the set of cells for L1/L2 mobility at L3 handover.

In some cases, physical layer (Layer 1 or L1) measurement may be enhanced for L1/L2 mobility, where a serving cell can be changed via L1/L2 signalling based on L1 measurement, and both synchronous and asynchronous source and target cells may be considered.

Various mechanisms and procedures of L1/L2 based inter-cell mobility may be specified for mobility latency reduction. These may include configuration and maintenance for multiple candidate cells to allow fast application of configurations for candidate cells. Dynamic switching mechanisms among candidate serving cells (including SpCell and SCell) may be supported for the potential applicable scenarios based on L1/L2 signaling.

L1 enhancements for inter-cell beam management, may include L1 measurement and reporting, as well as beam indication. Timing Advance (TA) management and CU-DU interface signaling may also be provided to support L1/L2 mobility.

L1/L2 based inter-cell mobility procedures may be applicable to a variety of scenarios. These scenarios may include standalone, CA and new radio-dual connectivity (NR-DC) cases with serving cell change within one cell group (CG), intra-distributed unit (DU) cases and intra-central unit (CU) inter-DU cases, intra-frequency and inter-frequency scenarios, both FR1 and FR2 scenarios, and scenarios where source and target cells may be synchronized or non-synchronized.

### Aspects Related to Selection and Reselection of ROs Under PRACH Adaptation

As noted above, the number or periodicity of SSB transmissions, as well as ROs for corresponding PRACH transmissions, may be adapted in the time domain. In such cases, PRACH adaptation may be implemented via a first step that involves RRC configuration of extra ROs (e.g., through a separate PRACH configuration index or a different PRACH periodicity) and a second step that involves activation of the configured extra ROs.

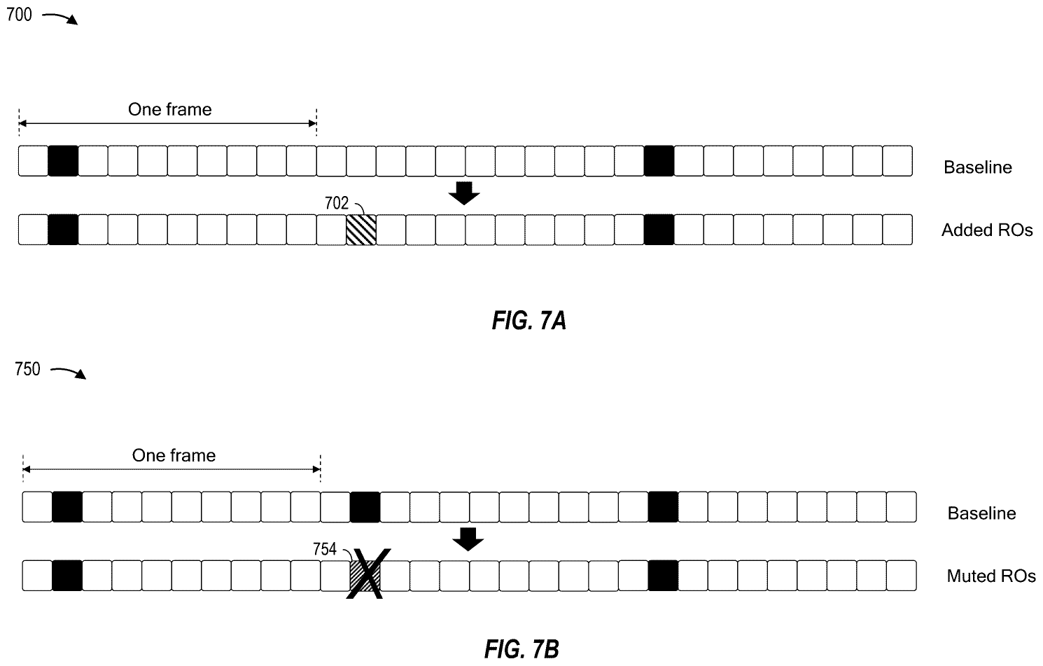

PRACH adaptation may involve adding or remove ROs. FIG. 7A depicts a diagram 700 illustrating an example of PRACH adaptation involving adding ROs. In the illustrated example, a baseline set of ROs includes two active ROs. As illustrated, after adaptation, an RO 702 is added. FIG. 7B depicts a diagram 750 illustrating example PRACH adaptation involving muting (removing) ROs. In the illustrated example, the baseline set of ROs includes three active ROs (e.g., the same as in FIG. 7A after adding RO 702 via PRACH adaptation). As illustrated, after PRACH adaptation, RO 754 is muted (removed).

As noted above, however, potential issues may arise if a UE selects one of the extra ROs (activated via PRACH adaptation) for a first PRACH transmission or for a PRACH retransmission. For example, if the UE selects one of the extra ROs and the network transmits a deactivation indication that the UE fails to detect, the UE may keep transmitting PRACH preambles on the same RO without receiving a network response (e.g., since the network will stop monitoring this RO after the deactivation).

Aspects of the present disclosure provide mechanisms that may help regulate selection and/or re-selection of ROs added via PRACH adaptation. The mechanisms may help the network encourage (or discourage) a UE from selecting certain ROs. For example, the network may signal one or more thresholds for the UE to apply before using extra ROs (e.g., based on reference signal received power-RSRP of corresponding SSBs). The threshold may help the network encourage only UEs located at a cell center to use added/extra ROs, because they have a higher reliability in receiving an adaptation indication (e.g., deactivating extra ROs).

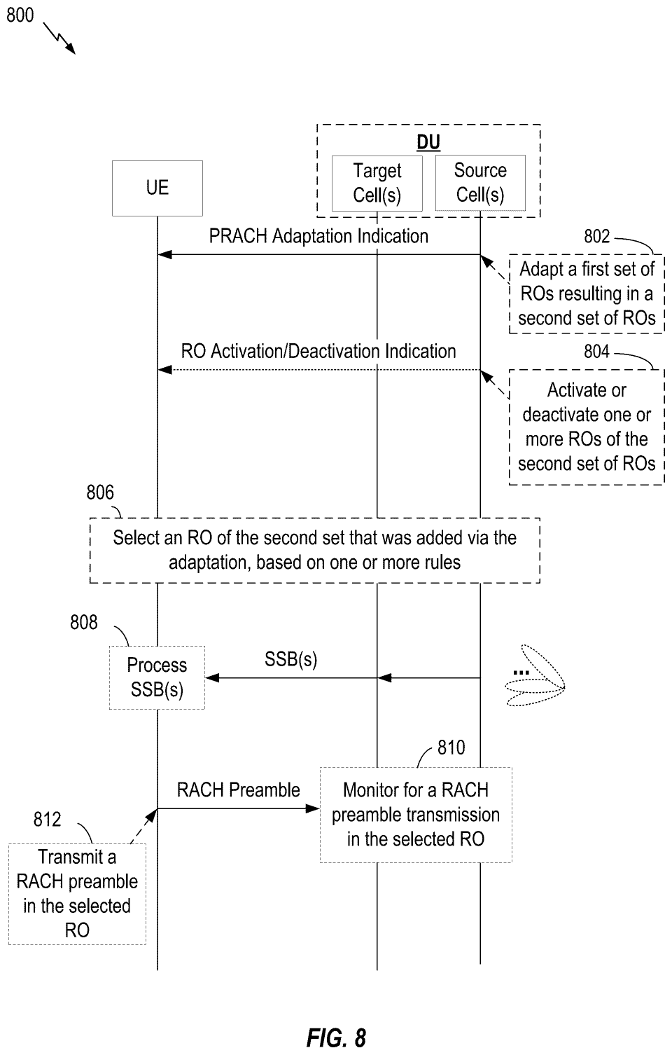

FIG. 8 depicts a call flow diagram 800 illustrating techniques for selection and/or re-selection of ROs added via PRACH adaptation, in accordance with aspects of the present disclosure.

In some aspects, the UE shown in FIG. 8 may be an example of the UE 104 depicted and described with respect to FIGS. 1 and 3. Similarly, the network entities (e.g., target cell(s), source cell(s), and/or DU) shown in FIG. 8 may be examples of the BS 102 (e.g., a gNB) depicted and described with respect to FIGS. 1 and 3 or a disaggregated base station depicted and described with respect to FIG. 2. As illustrated, in some cases, the network entity may include a DU that is associated with a source cell and one or more target cells (e.g., candidate cells for LTM).

As illustrated at 802, the network (e.g., source cell(s)) may transmit a PRACH adaptation indication, indicating adaptation of a first set of ROs resulting in a second set of ROs. As illustrated at 804, the network (e.g., source cell(s)) may transmit an RO activation/deactivation indication, activating or deactivating one or more ROs of the second set of ROs.

As illustrated at 806, the UE and the network may select an RO of the second set that was added via the adaptation, based on one or more rules.

As illustrated at 808, the UE may process one or more SSBs transmitted (e.g., using different beams) by the network (e.g., target cell(s)). In some cases, the SSBs may be transmitted in ROs according to a mapping of SSBs to ROs.

As illustrated at 810, the network (e.g., target cell(s)) may monitor for a RACH preamble on the selected RO. As illustrated at 812, the UE may transmit a RACH preamble in the selected RO.

In scenarios involving PRACH adaptation of ROs, there may be a set (e.g., a baseline set) of ROs that are always monitored by the network regardless of an adaptation method. Additionally, as described above with reference to FIGS. 7A and 7B, there may be a set of ROs that are either added or removed by PRACH adaptation, which may be referred to as the adaptation set.

According to certain aspects of the present disclosure, when a UE initiates a random access procedure (e.g., transmitting a RACH preamble), it may select a RO from the baseline set or the adaptation set according to one or more rules.

According to a first option (Option 1), if the adaptation set is active (e.g., activated), the network may indicate (e.g., in system information (SI)) a first RSRP threshold for the selection of the ROs from the adaptation set. In some aspects, the first RSRP threshold may be different from a second RSRP threshold configured/indicated for the baseline set. In some aspects, the threshold may be different for each beam.

This first option may allow the network to encourage or discourage (e.g., increase or decrease the likelihood of) the UEs using these extra (adapted) ROs based on their RSRP. In some aspects, the network may encourage only certain UEs (e.g., cell center UEs) to use added ROs, for example, because they have a higher reliability for receiving the adaptation indication.

According to a second option (Option 2), the UE may select an RO from the adaptation set (e.g., if it is activated). This second option may help to reduce collisions. If the adaptation set is activated, it may only be visible to certain UEs (e.g., 3GPP R19 UEs). According to this second option, if the adaptation set is deactivated then the UE may be forced to select from the baseline set.

According to a third option (Option 3), RO selection/reselection may be up to UE implementation. For example, a UE operating according to this third option may select to operate according to the first option, the second option, a hybrid of the first and second options, or an entirely different set of rules.

According to certain aspects, newly activated (e.g., adapted) ROs may have special properties and/or configurations. For example, they could be mapped to certain beams and/or may have different RACH preambles to be used for a RACH procedure. If a UE selects an RO from one set, it may be difficult for the UE to switch the chosen set of ROs in a retransmission (e.g., due to differences in configurations/properties). For example, power control configurations/properties may differ between the baseline set and the adapted set of ROs.

According to certain aspects, certain rules may dictate that once a UE makes a selection of the set of ROs to be used for PRACH transmission, the UE is to maintain the selection for consequent retransmissions, for at least a minimum number of transmissions.

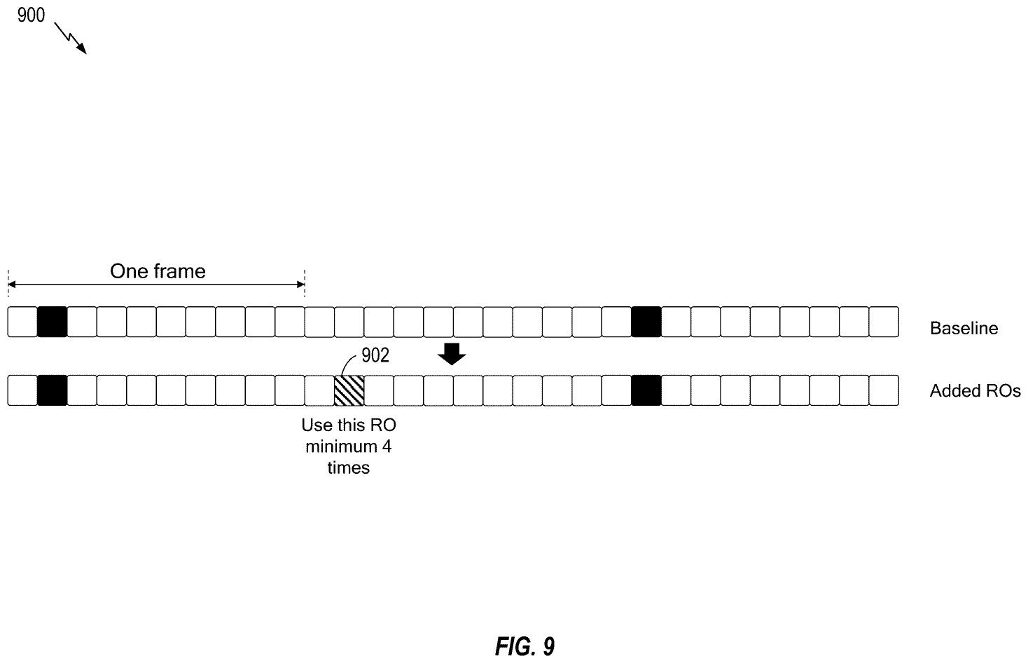

FIG. 9 depicts a diagram 900 illustrating PRACH adaptation adding RO(s) and a rule indicating to use an added RO for at least a minimum number of PRACH preamble (re)transmissions, in accordance with aspects of the present disclosure. As illustrated at 902, for example, certain rules may dictate that the UE is to use a particular RO (e.g., selected from the adaptation set) or ROs from the adaptation set for a minimum of 4 transmissions (e.g., retransmissions). After the minimum number of transmissions, if/when the UE switches the selected RO set, the UE may (e.g., or may not) reset the transmit power (e.g., based on network indication).

In some cases, if the UE continues transmitting on activated ROs, and the UE misses a deactivation indication, subsequent RACH preamble transmissions will not be successful (e.g., as the network is not monitoring for RACH preambles in the deactivated ROs). In some aspects, a maximum counter for using the ROs in the adaptation set may be defined.

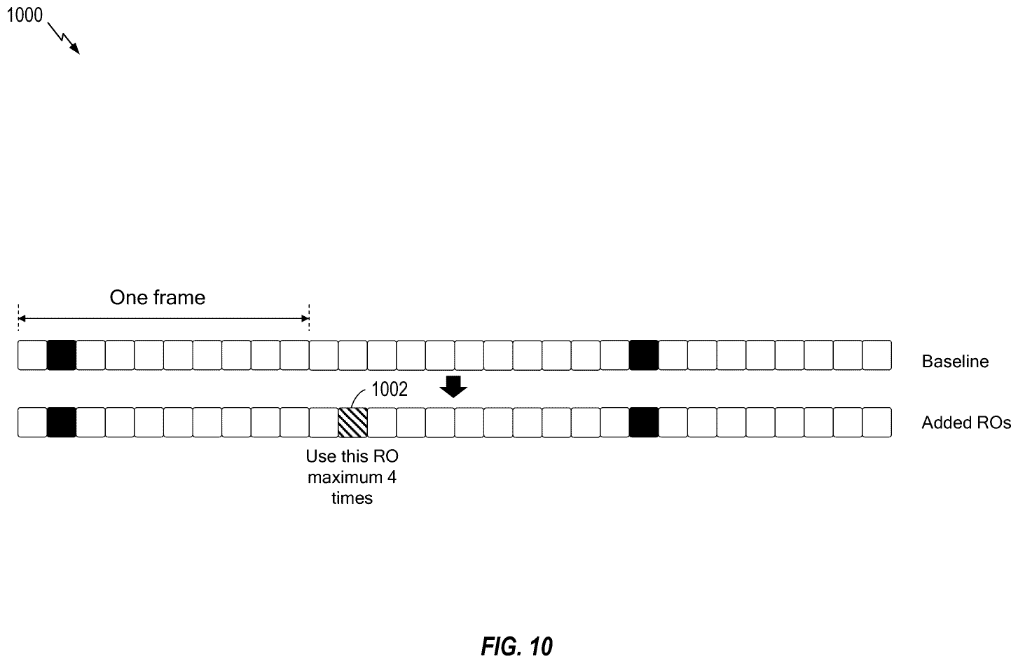

FIG. 10 depicts a diagram 1000 illustrating PRACH adaptation adding RO(s) and a rule indicating to use an added RO for up to a maximum number of PRACH preamble (re)transmissions, in accordance with aspects of the present disclosure. In some aspects, the network may indicate a UE with a maximum counter that defines the maximum number of times a UE (e.g., a 3GPP R19 UE) can use ROs from the adaptation set. In other words, once the maximum number is reached, the UE may assume the corresponding RO has been deactivated.

As illustrated at 1002, for example, certain rules (e.g., indicated by the network) may dictate that the UE is to use a particular RO (e.g., selected from the adaptation set) or ROs from the adaptation set for a maximum of 4 transmissions (e.g., retransmissions). If/when the UE uses the ROs from the adaptation set a number of times equal to the indicated maximum, subsequent transmissions should be in the baseline set of ROs.

In some aspects, the network may mute some ROs without explicitly informing the UE. In such cases, it may be beneficial that the UE knows which ROs or which set(s) of ROs are subject to such muting, so that certain UEs (e.g., that support adaptation) may avoid these ROs in case of a repetitive failure in PRACH transmission.

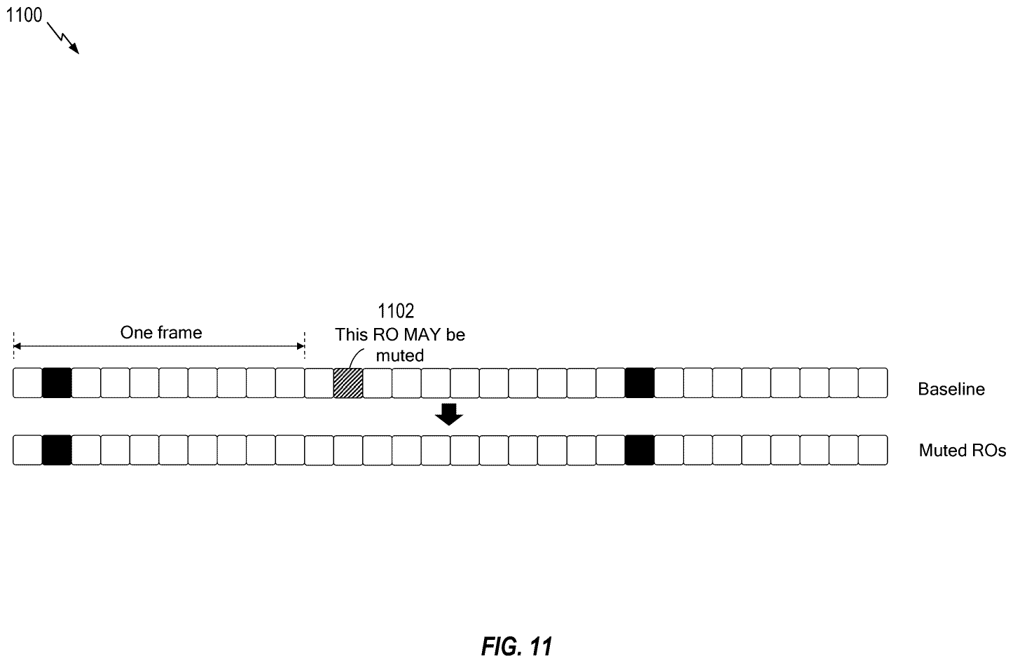

According to certain aspects of the present disclosure, the network may indicate a potential set of ROs that may be implicitly muted without (additional) indication. FIG. 11 depicts a diagram 1100 illustrating an indication that one or more ROs may be implicitly muted without additional indication, in accordance with aspects of the present disclosure. As illustrated at 1102, the network may indicate a particular RO that may be muted. In some aspects, the network may indicate multiple ROs, or one or more sets of ROs that may be implicitly muted without (additional) indication.

A UE that has received an indication of one or more ROs or sets of ROs that may be muted implicitly may not use these ROs after a number of retransmissions (e.g., X) of PRACH over these ROs. In some aspects, the number X may be indicated in system information (SI). In some aspects, the network may indicate X=0, which may effectively mean that a UE is never allowed to use the indicated ROs. If X=4, the UE is allowed to use them up to 4 times (e.g., which may or may not be consecutive) during a random access process.

### Example Operations

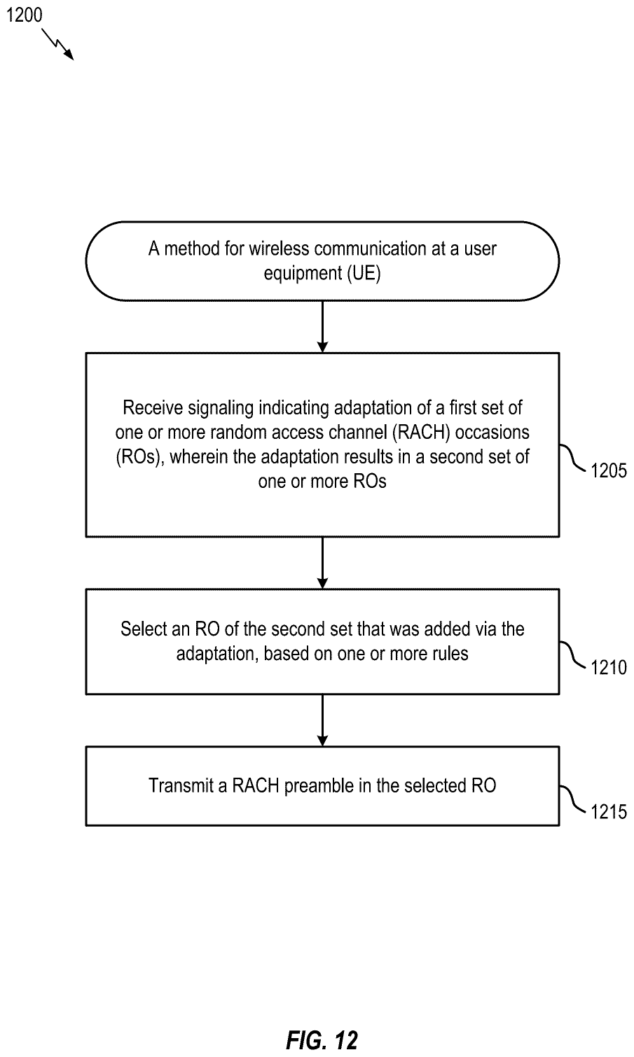

FIG. 12 shows an example of a method 1200 of wireless communication at a user equipment (UE), such as a UE 104 of FIGS. 1 and 3.

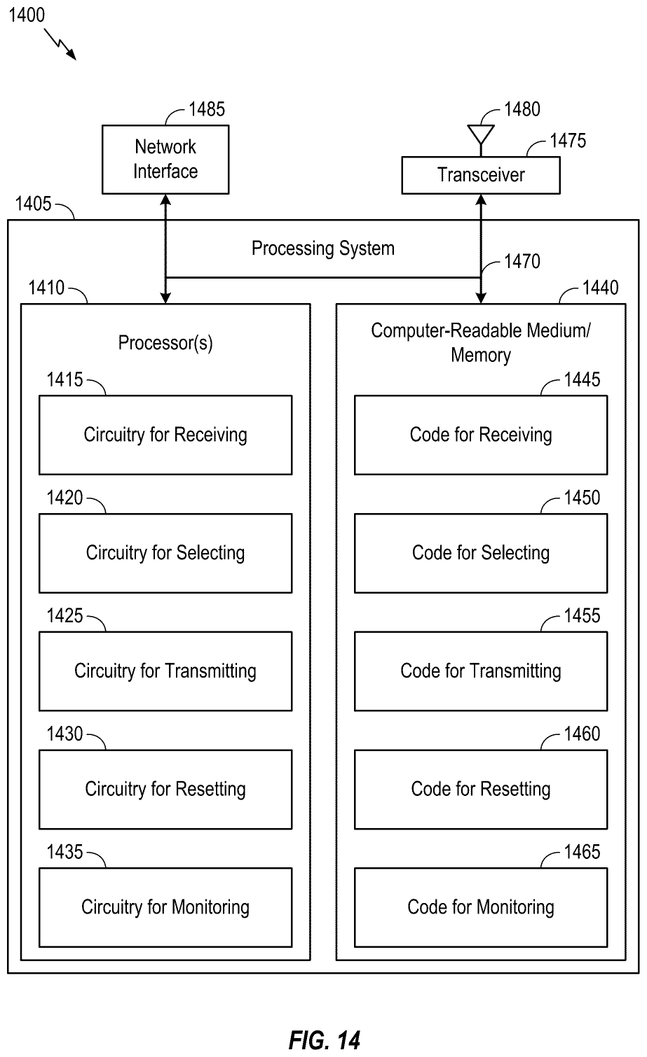

Method 1200 begins at step 1205 with receiving signaling indicating adaptation of a first set of one or more random access channel (RACH) occasions (ROs), wherein the adaptation results in a second set of one or more ROs. In some cases, the operations of this step refer to, or may be performed by, circuitry for receiving and/or code for receiving as described with reference to FIG. 14.

Method 1200 then proceeds to step 1210 with selecting an RO of the second set that was added via the adaptation, based on one or more rules. In some cases, the operations of this step refer to, or may be performed by, circuitry for selecting and/or code for selecting as described with reference to FIG. 14.

Method 1200 then proceeds to step 1215 with transmitting a RACH preamble in the selected RO. In some cases, the operations of this step refer to, or may be performed by, circuitry for transmitting and/or code for transmitting as described with reference to FIG. 14.

In some aspects, the one or more rules dictate that an RO of the second set is selected only if a corresponding synchronization signal block (SSB) measurement exceeds a threshold value.

In some aspects, the threshold value is indicated via system information (SI).

In some aspects, the one or more rules dictate that an RO of the second set is selected, when activated, rather than an RO of the first set.

In some aspects, the one or more rules dictate that, after the UE selects an RO of the second set, the UE is also to select an RO of the second set for at least a minimum number of one or more subsequent PRACH preamble retransmissions.

In some aspects, the method 1200 further includes selecting an RO of the first set after selecting an RO of the second set for at least the minimum number of one or more subsequent PRACH preamble retransmissions. In some cases, the operations of this step refer to, or may be performed by, circuitry for selecting and/or code for selecting as described with reference to FIG. 14.

In some aspects, the method 1200 further includes resetting transmit power control parameters for a PRACH preamble transmission on the RO selected from the first set. In some cases, the operations of this step refer to, or may be performed by, circuitry for resetting and/or code for resetting as described with reference to FIG. 14.

In some aspects, the one or more rules dictate that the UE is only able to use the selected RO for a maximum number of PRACH preamble transmissions or retransmissions.

In some aspects, the method 1200 further includes receiving an indication that one or more ROs of the second set may be implicitly muted without additional indication. In some cases, the operations of this step refer to, or may be performed by, circuitry for receiving and/or code for receiving as described with reference to FIG. 14.

In some aspects, the one or more rules dictate that the UE may not select one of the ROs that may be implicitly muted, after a certain quantity of zero or more PRACH preamble transmissions or retransmissions using this RO.

In some aspects, the quantity is indicated via system information (SI).

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

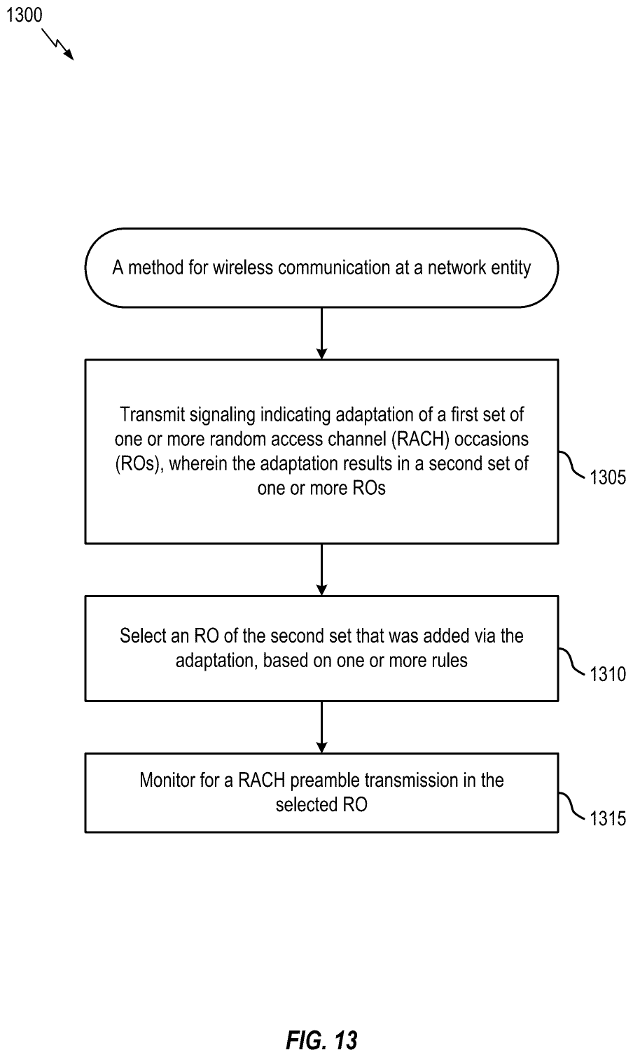

FIG. 13 shows an example of a method 1300 of wireless communication at a network entity, such as a BS 102 of FIGS. 1 and 3, or a disaggregated base station as discussed with respect to FIG. 2.

Method 1300 begins at step 1305 with transmitting signaling indicating adaptation of a first set of one or more random access channel (RACH) occasions (ROs), wherein the adaptation results in a second set of one or more ROs. In some cases, the operations of this step refer to, or may be performed by, circuitry for transmitting and/or code for transmitting as described with reference to FIG. 14.

Method 1300 then proceeds to step 1310 with selecting an RO of the second set that was added via the adaptation, based on one or more rules. In some cases, the operations of this step refer to, or may be performed by, circuitry for selecting and/or code for selecting as described with reference to FIG. 14.

Method 1300 then proceeds to step 1315 with monitoring for a RACH preamble transmission in the selected RO. In some cases, the operations of this step refer to, or may be performed by, circuitry for monitoring and/or code for monitoring as described with reference to FIG. 14.

In some aspects, the one or more rules dictate that an RO of the second set is selected only if a corresponding synchronization signal block (SSB) measurement exceeds a threshold value.

In some aspects, the threshold value is indicated via system information (SI).

In some aspects, the one or more rules dictate that an RO of the second set is selected, when activated, rather than an RO of the first set.

In some aspects, the one or more rules dictate that, after selection of an RO of the second set, the network entity is also to select an RO of the second set for monitoring at least a minimum number of one or more subsequent PRACH preamble retransmissions.

In some aspects, the one or more rules dictate that the selected RO is only to be used for monitoring for a maximum number of PRACH preamble transmissions or retransmissions.

In some aspects, the method 1300 further includes transmitting an indication that one or more ROs of the second set may be implicitly muted without additional indication. In some cases, the operations of this step refer to, or may be performed by, circuitry for transmitting and/or code for transmitting as described with reference to FIG. 14.

In one aspect, method 1300, or any aspect related to it, may be performed by an apparatus, such as communications device 1400 of FIG. 14, which includes various components operable, configured, or adapted to perform the method 1300. Communications device 1400 is described below in further detail.

Note that FIG. 13 is just one example of a method, and other methods including fewer, additional, or alternative steps are possible consistent with this disclosure.

### Example Communications Device(s)

FIG. 14 depicts aspects of an example communications device 1400. In some aspects, communications device 1400 is a user equipment, such as UE 104 described above with respect to FIGS. 1 and 3. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1475 (e.g., a transmitter and/or a receiver). In some aspects (e.g., when communications device 1400 is a network entity), processing system 1405 may be coupled to a network interface 1485 that is configured to obtain and send signals for the communications device 1400 via communication link(s), such as a backhaul link, midhaul link, and/or fronthaul link as described herein, such as with respect to FIG. 2. The transceiver 1475 is configured to transmit and receive signals for the communications device 1400 via the antenna 1480, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1440 via a bus 1470. In certain aspects, the computer-readable medium/memory 1440 is configured to store instructions (e.g., computer-executable code) that when executed by the one or more processors 1410, cause the one or more processors 1410 to perform the method 1200 described with respect to FIG. 12, or any aspect related to it; and the method 1300 described with respect to FIG. 13, or any aspect related to it. Note that reference to a processor performing a function of communications device 1400 may include one or more processors 1410 performing that function of communications device 1400.

In the depicted example, computer-readable medium/memory 1440 stores code (e.g., executable instructions), such as code for receiving 1445, code for selecting 1450, code for transmitting 1455, code for resetting 1460, and code for monitoring 1465. Processing of the code for receiving 1445, code for selecting 1450, code for transmitting 1455, code for resetting 1460, and code for monitoring 1465 may cause the communications device 1400 to perform the method 1200 described with respect to FIG. 12, or any aspect related to it; and the method 1300 described with respect to FIG. 13, or any aspect related to it.

The one or more processors 1410 include circuitry configured to implement (e.g., execute) the code stored in the computer-readable medium/memory 1440, including circuitry for receiving 1415, circuitry for selecting 1420, circuitry for transmitting 1425, circuitry for resetting 1430, and circuitry for monitoring 1435. Processing with circuitry for receiving 1415, circuitry for selecting 1420, circuitry for transmitting 1425, circuitry for resetting 1430, and circuitry for monitoring 1435 may cause the communications device 1400 to perform the method 1200 described with respect to FIG. 12, or any aspect related to it; and the method 1300 described with respect to FIG. 13, or any aspect related to it.

Various components of the communications device 1400 may provide means for performing the method 1200 described with respect to FIG. 12, or any aspect related to it; and the method 1300 described with respect to FIG. 13, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1475 and the antenna 1480 of the communications device 1400 in FIG. 14. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1475 and the antenna 1480 of the communications device 1400 in FIG. 14.

### Example Clauses

Implementation examples are described in the following numbered clauses:

Clause 1: A method for wireless communication at a user equipment (UE), comprising: receiving signaling indicating adaptation of a first set of one or more random access channel (RACH) occasions (ROs), wherein the adaptation results in a second set of one or more ROs; selecting an RO of the second set that was added via the adaptation, based on one or more rules; and transmitting a RACH preamble in the selected RO.

Clause 2: The method of Clause 1, wherein the one or more rules dictate that an RO of the second set is selected only if a corresponding synchronization signal block (SSB) measurement exceeds a threshold value.

Clause 3: The method of Clause 2, wherein the threshold value is indicated via system information (SI).

Clause 4: The method of any one of Clauses 1-3, wherein the one or more rules dictate that an RO of the second set is selected, when activated, rather than an RO of the first set.

Clause 5: The method of any one of Clauses 1-4, wherein the one or more rules dictate that, after the UE selects an RO of the second set, the UE is also to select an RO of the second set for at least a minimum number of one or more subsequent PRACH preamble retransmissions.

Clause 6: The method of Clause 5, further comprising: selecting an RO of the first set after selecting an RO of the second set for at least the minimum number of one or more subsequent PRACH preamble retransmissions; and resetting transmit power control parameters for a PRACH preamble transmission on the RO selected from the first set.

Clause 7: The method of any one of Clauses 1-6, wherein the one or more rules dictate that the UE is only able to use the selected RO for a maximum number of PRACH preamble transmissions or retransmissions.

Clause 8: The method of any one of Clauses 1-7, further comprising: receiving an indication that one or more ROs of the second set may be implicitly muted without additional indication.

Clause 9: The method of Clause 8, wherein the one or more rules dictate that the UE may not select one of the ROs that may be implicitly muted, after a certain quantity of zero or more PRACH preamble transmissions or retransmissions using this RO.

Clause 10: The method of Clause 9, wherein the quantity is indicated via system information (SI).

Clause 11: A method for wireless communication at a network entity, comprising: transmitting signaling indicating adaptation of a first set of one or more random access channel (RACH) occasions (ROs), wherein the adaptation results in a second set of one or more ROs; selecting an RO of the second set that was added via the adaptation, based on one or more rules; and monitoring for a RACH preamble transmission in the selected RO.

Clause 12: The method of Clause 11, wherein the one or more rules dictate that an RO of the second set is selected only if a corresponding synchronization signal block (SSB) measurement exceeds a threshold value.

Clause 13: The method of Clause 12, wherein the threshold value is indicated via system information (SI).

Clause 14: The method of any one of Clauses 11-13, wherein the one or more rules dictate that an RO of the second set is selected, when activated, rather than an RO of the first set.

Clause 15: The method of any one of Clauses 11-14, wherein the one or more rules dictate that, after selection of an RO of the second set, the network entity is also to select an RO of the second set for monitoring at least a minimum number of one or more subsequent PRACH preamble retransmissions.

Clause 16: The method of any one of Clauses 11-15, wherein the one or more rules dictate that the selected RO is only to be used for monitoring for a maximum number of PRACH preamble transmissions or retransmissions.

Clause 17: The method of any one of Clauses 11-16, further comprising: transmitting an indication that one or more ROs of the second set may be implicitly muted without additional indication.

Clause 18: An apparatus, comprising: at least one memory comprising executable instructions; and at least one processor configured to execute the executable instructions and cause the apparatus to perform a method in accordance with any combination of Clauses 1-17.

Clause 19: An apparatus, comprising means for performing a method in accordance with any combination of Clauses 1-17.

Clause 20: A non-transitory computer-readable medium comprising executable instructions that, when executed by at least one processor of an apparatus, cause the apparatus to perform a method in accordance with any combination of Clauses 1-17.

Clause 21: A computer program product embodied on a computer-readable storage medium comprising code for performing a method in accordance with any combination of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

Means for receiving, means for selecting, means for transmitting, means for resetting, and means for monitoring may comprise one or more processors, such as one or more of the processors described above with reference to FIG. 14.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the apparatus to:
receive signaling indicating adaptation of a first set of one or more random access channel (RACH) occasions (ROs), wherein the adaptation results in a second set of one or more ROs;
select an RO of the second set that was added via the adaptation, based on one or more rules; and
transmit a RACH preamble in the selected RO.

2. The apparatus of claim 1, wherein the one or more rules dictate that an RO of the second set is selected only if a corresponding synchronization signal block (SSB) measurement exceeds a threshold value.

3. The apparatus of claim 2, wherein the threshold value is indicated via system information (SI).

4. The apparatus of claim 1, wherein the one or more rules dictate that an RO of the second set is selected, when activated, rather than an RO of the first set.

5. The apparatus of claim 1, wherein the one or more rules dictate that, after the UE selects an RO of the second set, the UE is also to select an RO of the second set for at least a minimum number of one or more subsequent PRACH preamble retransmissions.

6. The apparatus of claim 5, wherein the one or more processors are further configured to execute the computer-executable instructions and cause the apparatus to:
select an RO of the first set after selecting an RO of the second set for at least the minimum number of one or more subsequent PRACH preamble retransmissions; and
reset transmit power control parameters for a PRACH preamble transmission on the RO selected from the first set.

7. The apparatus of claim 1, wherein the one or more rules dictate that the UE is only able to use the selected RO for a maximum number of PRACH preamble transmissions or retransmissions.

8. The apparatus of claim 1, wherein the one or more processors are further configured to execute the computer-executable instructions and cause the apparatus to:
receive an indication that one or more ROs of the second set may be implicitly muted without additional indication.

9. The apparatus of claim 8, wherein the one or more rules dictate that the UE may not select one of the ROs that may be implicitly muted, after a certain quantity of zero or more PRACH preamble transmissions or retransmissions using this RO.

10. The apparatus of claim 9, wherein the quantity is indicated via system information (SI).

11. An apparatus for wireless communication at a network entity, comprising:
transmitting signaling indicating adaptation of a first set of one or more random access channel (RACH) occasions (ROs), wherein the adaptation results in a second set of one or more ROs;
selecting an RO of the second set that was added via the adaptation, based on one or more rules; and
monitoring for a RACH preamble transmission in the selected RO.

12. The apparatus of claim 11, wherein the one or more rules dictate that an RO of the second set is selected only if a corresponding synchronization signal block (SSB) measurement exceeds a threshold value.

13. The apparatus of claim 12, wherein the threshold value is indicated via system information (SI).

14. The apparatus of claim 11, wherein the one or more rules dictate that an RO of the second set is selected, when activated, rather than an RO of the first set.

15. The apparatus of claim 11, wherein the one or more rules dictate that, after selection of an RO of the second set, the network entity is also to select an RO of the second set for monitoring at least a minimum number of one or more subsequent PRACH preamble retransmissions.

16. The apparatus of claim 11, wherein the one or more rules dictate that the selected RO is only to be used for monitoring for a maximum number of PRACH preamble transmissions or retransmissions.

17. The apparatus of claim 11, wherein the one or more processors are further configured to execute the computer-executable instructions and cause the apparatus to:
transmit an indication that one or more ROs of the second set may be implicitly muted without additional indication.

18. A method for wireless communication at a user equipment (UE), comprising:
receiving signaling indicating adaptation of a first set of one or more random access channel (RACH) occasions (ROs), wherein the adaptation results in a second set of one or more ROs;
selecting an RO of the second set that was added via the adaptation, based on one or more rules; and
transmitting a RACH preamble in the selected RO.

19. The method of claim 18, wherein the one or more rules dictate that an RO of the second set is selected only if a corresponding synchronization signal block (SSB) measurement exceeds a threshold value.

20. The method of claim 19, wherein the threshold value is indicated via system information (SI).
